(19) United States
(12) Patent Application Publication
(10) Pub. No.: US 2006/0078099 A1
(43) Pub. Date: Apr. 13, 2006

(54) Method, apparatus and system for restricted prepaid calling card

(76) Inventors: Sherrie L. Liebenow, Jefferson, SD (US); Frank Liebenow, Jefferson, SD (US)

Correspondence Address: LARSON AND LARSON, 11199 69TH STREET NORTH, LARGO, FL, 33773, US

(21) Appl. No.: 10/962,307

(22) Filed: Oct. 8, 2004

(51) Int. Cl. H04M 15/00

(52) U.S. Cl. 379/114.2; 379/114.15

(57) ABSTRACT

A system, method and apparatus for prepaid calling cards, providing prepaid phone system connections between calling parties and called parties, whereas said prepaid calling cards are authorized at a point of purchase and restrictions are created at the point of purchase such that said prepaid calling card cannot be used if said restrictions are violated. For example, a restriction of a preprogrammed phone number may be added at the point of purchase rendering that prepaid calling card useful only for calls made to the restricted phone number.

### FIELD OF THE INVENTION

The present invention generally relates to the field of pre-paid calling cards, and in particular where the purchaser wants the card to be restricted to calling a single phone number, a list of phone numbers or other desired restrictions.

### BACKGROUND OF THE INVENTION

Pre-paid calling cards have been in public use for many years. These cards are sometimes lost or stolen, and sometimes not used for what the purchaser intended. In order to prevent misuse, it may be desirable to restrict the set of phone numbers that the prepaid calling card can be used to call. For example, a parent who purchases a phone card for a child who is in college at a location where they might incur toll charges to call home. The parent may want to give the child a prepaid calling card, but may not want the child to be free to call anybody else using that prepaid calling card. When the prepaid calling card is purchased, the parent may want to set up a restriction list that contains phone numbers that can be dialed using the card so that the child can only use that card to call the parent. This list may be established when the card is activated, perhaps using the equipment already in place for activating the card. Presently, there is no method for a purchaser to do so at the place of purchase.

U.S. Pat. No. 5,903,633 to Lorsch, “Method and Apparatus for Prepaid calling card Activation and Billing,” which is hereby included by reference, explains how prepaid calling cards may be distributed to retailers, each having an account number. This patent shows how to activate one of a plurality of pre-paid calling cards at a retail location using a point of sale terminal that reads an identification code from the prepaid calling card, perhaps an identification code that is encoded on a magnetic strip of the prepaid calling card. This patent does not include an important feature of the present invention, but provides a mechanism for activating the prepaid calling cards at the point of purchase.

U.S. Pat. No. 5,825,863 to Walker, “Prepaid Limited Usage Calling Card,” hereby included by reference, presents a system for restricting a prepaid calling card, but requires the purchaser to activate the card, then call an 800 number to administer phone numbers and limits by entering various combinations of digits, “*” and “#” on a standard phone keypad. Although this may produce similar results, it requires extra steps by the purchaser and creates a very limited user interface because of the limitations of the standard phone keypad. The difficulty in understanding and setting up restrictions may deter a large population of potential users from taking advantage of this feature. Furthermore, someone using a rotary dial phone cannot administer this system.

Throughout this description, prepaid phone card, prepaid calling card, calling card and phone card are used interchangeably to describe a card that has associated with it an account code, which is, preferably, unique. This number is likely encoded onto a magnetic strip or stripe, stored in a memory, encoded into a barcode, or encoded in many other ways known in the industry. Furthermore, this account code may be printed on a surface of the card so that the user can enter this number when establishing a call. Additionally, instructional information as well as an access number, preferably a toll-free number, may be also printed on the card so that a user may be able to use the card by dialing the access number, entering the account code, then after being authorized, entering the number they wish to call, all using the keypad of a telephone.

### SUMMARY OF THE INVENTION

The present invention is directed to a means of restricting a prepaid calling card so that it can be used to dial only certain phone numbers and/or can be used at specified times, and/or can be used on specified dates and/or can be restricted as to the number of calling units per time period allowed (for example, allow 100 minutes per week). The restricted list may reside in the magnetic stripe of the phone card itself, in any other memory means located in or on the phone card or the list may reside within the telephone network, perhaps on a storage device such as a hard disk, perhaps in a database that may be accessed when the card is used. The present invention has a feature, whereby the desired restrictions are captured at the point of purchase, possibly on a point of sale terminal. In this manner, the customer may request a large variety of restrictions and a trained salesperson or the customer may enter this information into the point of sale terminal for association with the purchased calling card. The restrictions may be, one or more allowed numbers that can be called, one or more prohibited numbers that can't be called, the number of calling units per time period allowed, usage time or date restrictions, etc. For example, a calling card can be restricted to be allowed to call either a first phone number or a second phone number, only on Saturdays or Sundays, only between 9:00 AM and 9:30 PM and a maximum of 100 calling units may be used per week. Calling units are usually prepaid minutes.

In one embodiment, the restrictions are entered in a point-of-sale terminal and programmed into or onto the prepaid calling card's memory for use when the card is swiped.

In another embodiment, the restrictions are entered in a point-of-sale terminal and forwarded to a central database along with other activation information so that when the card is used, the number (or numbers); time or date; and/or limits per period are checked at the same time the card is authorized is checked for making the desired call.

It is to be understood that both the forgoing general description and the following detailed description are exemplary only and are not restrictive of the invention as claimed. The general functions of this invention may be combined in different ways to provide the same functionality while still remaining within the scope of this invention. The embodiments have a point-of-sale terminal as the device in which the restricted set of phone numbers is entered, but said device can be any device that resides at the point of purchase, including a point-of-sale terminal, a credit-card authorization device, a kisok, a device made specially to program prepaid calling cards or any other device that has the ability to allow entry of the restrictions and can effect the system changes required to transfer the set of restrictions for access when the prepaid calling card is used.

### BRIEF DESCRIPTION OF THE DRAWINGS

The numerous advantages of the present invention may be better understood by those skilled in the art by reference to the accompanying figures in which:

FIG. 1 shows a block diagram of the present invention.

FIG. 2 shows a flow chart of the present invention.

FIG. 3 shows a typical point of sale user interface of the present invention.

FIG. 4 shows a flow chart of a system for making calls using prepaid calling cards of the present invention.

### DETAILED DESCRIPTION

Reference will now be made in detail to the presently discussed embodiment of the invention, an example of which is illustrated in the accompanying drawings.

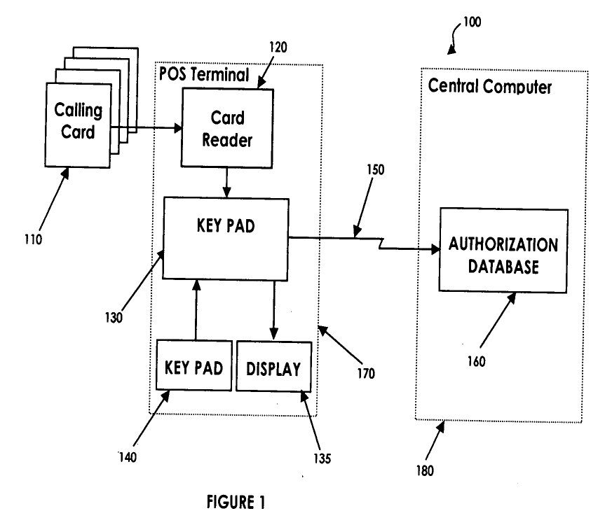

Referring now to FIG. 1, a block diagram of a hardware system in accordance with the present invention is shown. The hardware system shown in FIG. 1 shows a plurality of prepaid calling cards 110 ready to be activated. These prepaid calling cards may have a magnetic strip or any of a variety of means for storing information upon the prepaid calling card such as: a bar code, a RFID tag, a smart-card memory, etc. It is advantageous for the memory means to provide the capability of information on the card to be read by a reading device 120 at the point of sale terminal 170. One of this plurality of prepaid calling cards is read by Card Reader 120, where information identifying the individual prepaid calling card is read and transferred to the point of sale controller 130. This is sometimes called swiping the prepaid calling card or scanning the prepaid calling card. The information may include a code that identifies the type of card as well as an identification code or serial number that identifies the unique card so that as it is used in the future, the correct account may be debited, sometimes known as an account code or account information. Other information may be included in the information that may or may not be used by this present invention, such as the number of message units or minutes that are prepaid, an expiration date, encryption information, etc. The term prepaid refers to calling cards whereas the purchase pays an upfront fee for a specified number of message units, hence, the message units are paid for before they are used, or prepaid. These prepaid calling cards are prevalent in retail stores, sometimes in denominations of 300, 600, 900, 1200 and 2000 minutes. While they are on the retail shelf, they have no value, possibly preventing theft since they may be easy to conceal. Only after they are authorized at the retailer's point of sale terminal, are they validated, e.g., only after they are “prepaid.”

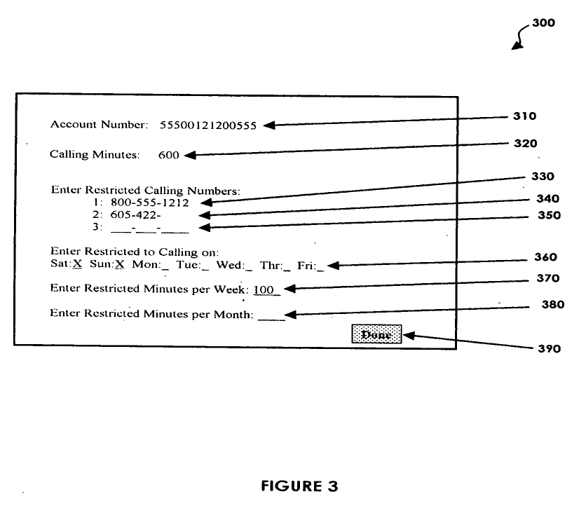

Once the scanned information is present in point of sale controller 130, the retailer may be presented with a form on display 135, allowing the retailer or customer to input restrictions that the purchaser of the card may desire. These restrictions may be entered using a keypad 140 or other similar data entry device such as a keyboard, set of switchers or touch-screen input. A sample of this form is shown in FIG. 3 and will be explained later. The retailer may enter various restrictions, including: phone numbers that the prepaid calling card is allowed to dial, days of the week that the card is allowed to make calls upon, restrictions on the number of message units (minutes) allowed to be used per week or month, time periods upon which the card may be used, etc. Once all restrictions are entered, a finish operation is executed, possibly using a special key on keypad 140, a designated key on a keyboard, such as “Enter,” or by selecting an icon on a touch screen, perhaps labeled “Done” or “Send.” When the finish operator is executed, point of sale controller 130 assembles various information related to the card along with any restrictions entered and transmits these in a packet of information over communications link 150 to, perhaps, a central computer system 180. Communications link 150 may be any form of communications links known, or a combination of communications links, perhaps a dial-up connection, Ethernet link, wireless link such as 802.11, dedicated connection such as RS-232, Universal Serial Bus, IEEE 1394 (Firewire), DOCSIS (cable modem), DSL (Digital Subscriber Loop) or the like. An example of a combination might be wireless (802.11) through to an access point, then broadband (e.g., DOCSIS or DSL) to the centralized computer. Central computer system 180 may then authorize the prepaid calling card and enter the authorization information along with the restrictions into authorization database 160 for access each time the prepaid calling card is used. An acknowledgement may be sent back from central computer system 180 to point of sale controller 130. Point of sale controller 130 may be a micro controller or microprocessor or other fixed or stored program device known in the industry and commonly used to control a point of sale terminal. It may include persistent storage such as a hard drive, ROM or FLASH for program storage and a memory for program execution and temporary storage of information.

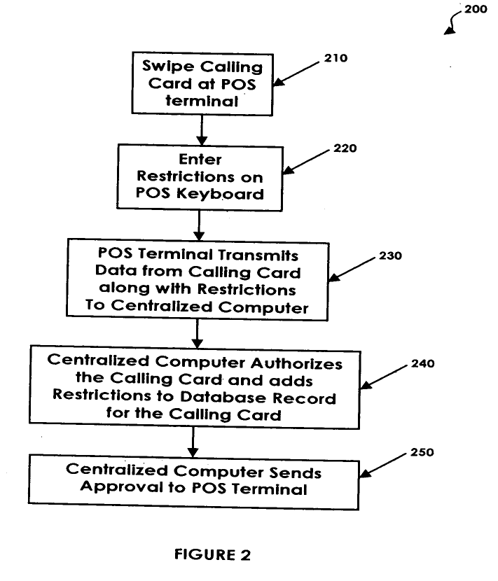

Referring now to FIG. 2, a flow chart of the operation of the present invention is shown. The operation starts when a prepaid calling card is read by “swiping” the calling card at the point of sale (POS) terminal 210. For magnetic strip calling cards, the step would be sliding the card through a slot that has a magnetic reading head to read the information from the card along with error detection and correction information used to assure an accurate reading of the information. If an error occurs in this step, a warning is presented and the retailer is prompted to run the card through the reader again. Although this embodiment demonstrates how this invention would work with a prepaid calling card having a magnetic strip for storage of information, such as account information, similar embodiments are anticipated using many different methods of encoding information onto prepaid calling cards, including smart cards, cards with bar codes, cards with printed digits that are recognized by character recognition and any other method of storing information for retrieval by the point of sale terminal 170. At step 220, the retailer or purchaser enters any desired restrictions. These restrictions may be made at the main data entry device for the point of sale terminal 170, perhaps a keyboard, set of dedicated keys or touch screen; and may alternately be entered by the purchaser at an auxiliary data entry device, perhaps a keyboard, set of dedicated keys or touch screen configured for the purchaser to operate. These restrictions may include one or more phone numbers (or part of a phone number) that the calling card is enabled to call, one or more phone numbers (or part of a phone number) that the calling card is not enabled to call, a restriction as to what day or days of the week the card may be used, a restriction of the number of minutes per week the card may be used, a restriction of the number of minutes per month the card may be used, a restriction on the time of day the card may be used, etc. By restricting to part of a phone number, the card may be allowed to call all numbers in a given area code and branch exchange; for example, all numbers in area code 605 and branch exchange 422 would be entered as 605-422.

Once all restrictions are entered at the point of sale terminal, the point of sale terminal connects with the centralized computer and transmits the restriction data along with other data read from the card and perhaps other data from the retailer to the centralized computer 230. The Communications may be any form of communications known, or a combination of communications, perhaps a dial-up connection, Ethernet link, wireless link such as 802.11, dedicated connection such as RS-232, Universal Serial Bus, IEEE 1394 (Firewire), DOCSIS (cable modem), DSL (Digital Subscriber Loop) or the like. An example of a combination might be wireless (802.11) through to an access point, then broadband (e.g., DOCSIS or DSL) to the centralized computer. The centralized computer system may be local to the retailer or it may be at a remote location where many retailers may access the same centralized computer. The central computer system 180 may then authorize the prepaid calling card and enter the authorization information along with the restrictions into authorization database 160 for access each time the prepaid calling card is used in step 240. Finally, in step 250, the central computer sends an approval back to point of sale terminal 170 to indicate that the prepaid calling card is now ready to use.

Referring now to FIG. 3, an example of a data entry screen that may be presented on the point of sale terminal for the retailer or the customer to enter restriction information is illustrated. In this example, the retailer or customer enters restriction information, possibly using a keyboard, keypad, touch-screen or any similar data entry device. The point of sale terminal may display the prepaid calling card's account number 310 for identification purposes, then presents various fill-in or selection fields on the display. These fields may include the number of message units (or minutes) desired 320, should the prepaid calling card have a variable number of minutes allowed. This field may also be a selection field, perhaps allowing 600, 900, 1200, etc., minutes to be selected. Field 330, 340 and 350 lets the retailer or customer enter one or more phone numbers, restricting the prepaid calling card to only be used to call numbers on this list. In this example, the retailer or customer may enter up to three restricted numbers, but in other user interfaces, any number of restricted numbers may be entered. Furthermore, in other embodiments, negative restriction numbers may be entered, for example, phone numbers that are not permitted, perhaps a number that the customer doesn't want the card to be able to access. In this example, a complete phone number has been entered into position 330. This would allow the card to be used to dial the number entered in this field 330, in this example, 800-555-1212. In field 340, a partial phone number has been entered, 605-422. This may allow the card to dial any number in the given area code of 605 and branch exchange of 422, allowing the range of phone numbers from 605422-0000 through 605-422-9999. Although shown using North America Dialing Plan formats, the present invention works just as well for other dialing formats, such as those used in other countries. Furthermore, the present invention is easily adaptable to allow the addition of country codes for international dialing.

Continuing with FIG. 3, section 360 allows the prepaid calling card to be restricted to only be used on certain days of the week. In this example, Saturday and Sunday are marked, therefore, the prepaid calling card may only be used on these days. If no days are checked, perhaps the prepaid calling card can be used any day of the week. Fields 370 and 380 allow the customer to specify a limit on the number of minutes that can be used in a given week 370 or month 380. In this example, a restriction of 100 minutes per week 370 has been specified, allowing the card to be used at most 100 minutes each week until it runs out. There is no reason why the prepaid calling card couldn't be refilled at any time through existing mechanisms known in the industry.

When all restrictions are set to values desired by the customer, the customer or retailer initiates a complete function to tell the point of sale terminal to send the information to the central computer (see description of FIG. 2). There are many ways known in the industry to complete a function, including pressing a special key on a keypad or keyboard such as “Enter” or “Send,” or using a pointing device to select an icon or word on the screen, such as “DONE” 390.

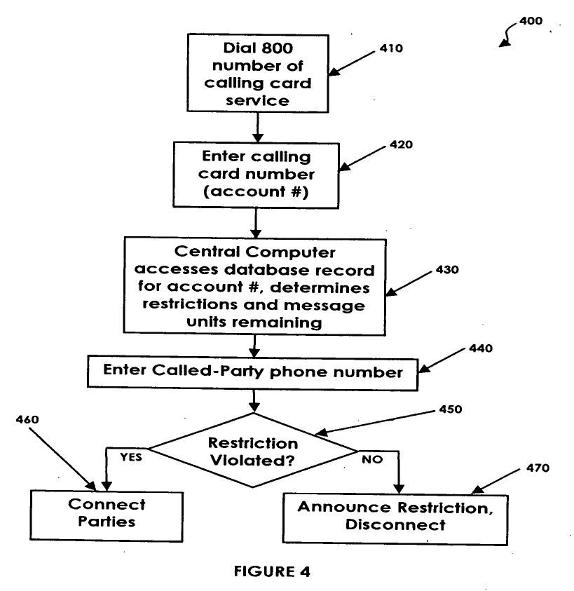

Referring now to FIG. 4, a flow chart of a system for making calls according to the present invention is shown. At 410, the user of the prepaid calling card dials a toll-free number, generally 800 or 888 numbers in the United States. This method of prepaid calling card usage is known in the industry, as the toll-free number is usually printed on the front or back of the prepaid calling card. Once connected, the user enters the account number for the prepaid calling card 420, which is usually printed on the face of the prepaid calling card. The account number may be entered by typing the digits on the phone's keypad, followed by pressing the ‘#’ key on the keypad to indicate completion. In another embodiment, perhaps at pay phones, the prepaid calling card may be passed through a reading device of the phone and the toll-free number and account number may be read and passed to the phone network without the user entering such information.

At step 430, the phone system accesses the database within the central computer to retrieve information about the prepaid calling card, using the account number as a key. This method is known in the industry and is already in use for determining validity of prepaid calling cards as well as keeping track of remaining message units. In addition, the information about the prepaid calling card also includes restriction information such as phone numbers or sets of phone numbers that can be dialed, phone numbers or sets of phone numbers that cannot be dialed, restricted days of use, restricted times of use, restricted message units that can be used per period of time (such as daily, weekly or monthly), etc.

At step 440, the user enters the phone number of the called party. This is done by methods known in the industry including entering the phone number on the phone keypad or abbreviated dialing using phone pre-stored phone numbers associated with the prepaid calling card, etc. In one embodiment, the abbreviated phone numbers may be the same as the restricted numbers, thereby allowing the user to dial the numbers that they are allowed to dial using an easier user interface.

At step 450, the desired caller phone number is checked against the restriction list as well as the time, date, day and message units counts to determine if the desired call is being made within the restrictions provided when the prepaid calling card was purchased. If the call is within the restrictions, the calling and called parties are connected 460, and the phone system proceeds as it would before this invention, tracing message units as they are used and debiting them from the prepaid calling card's account until no message units remain, at which time the call is disconnected. Other features may be present, without effect to the present invention, including warning before disconnect and allowing the user to pay for additional message units, perhaps using a credit card. If the call is not within restrictions at step 460, then the violation of restrictions is announced and the connection is disconnected 470. Note that the individual restriction may be announced, perhaps, “this prepaid calling card is not authorized to call this number,” or a predetermined announcement may say, “this prepaid card is restricted.”

Although the invention has been described with a certain degree of particularity, it should be recognized that elements thereof may be altered by persons skilled in the art without departing from the spirit and scope of the invention. It is believed that restricted prepaid calling card and method of setting restrictions of the present invention and many of its attendant advantages will be understood by the foregoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

What is claimed is:

1. An apparatus for prepaid calling card activation with restrictions, comprising:
a prepaid calling card having a magnetic strip, said magnetic strip encoded with at least account information, said account information configured to identify said prepaid calling card;
a point of sale terminal configured to scan said account information from said prepaid calling card, said point of sale terminal having a data entry and display device; and
at least one computer configured to receive and send information to and from said point of sale terminal, said computer having a database configured to store and track information related to said prepaid calling card,
whereas:
a set of restrictions is entered at said point of sale terminal;
said set of restrictions are sent to said at least one computer; and
said set of restrictions are associated by said at least one computer with said prepaid calling card and said set of restrictions are stored in said database.

2. An apparatus for prepaid calling card activation with restriction according to claim 1, wherein said set of restrictions includes at least one phone number, wherein said prepaid calling card can only be used to dial phone numbers that are included in said at least one phone number.

3. An apparatus for prepaid calling card activation with restriction according to claim 1, wherein said set of restrictions includes at least one phone number, wherein said prepaid calling card can not be used to dial phone numbers that are included in said at least one phone number.

4. An apparatus for prepaid calling card activation with restriction according to claim 1, wherein said set of restrictions includes at least one day of the week, wherein said prepaid calling card can only be used on days of the week that are included in said at least one day of the week.

5. An apparatus for prepaid calling card activation with restriction according to claim 1, wherein said set of restrictions includes at least one time range, wherein said prepaid calling card can only be used at times that are included in time ranges within said at least one time range.

6. An apparatus for prepaid calling card activation with restriction according to claim 1, wherein said set of restrictions includes at least one period restriction, said at least one period restriction includes a time period and a specified number of message units, wherein said prepaid calling card can only be used for said specified number of message units during said time period.

7. A method for prepaid calling card restriction comprising the steps of:
scanning said prepaid calling card through a point of sale terminal, said prepaid calling card having encoded information, said encoded information including account information, said account information configured to identify said prepaid calling card;
inputting at least one phone card restriction into said point of sale terminal;
transmitting said account information and said at least one phone restriction from said point of sale terminal to a centralized computer means; and
storing said account information and said at least one phone card restriction in a database within said centralized computer means.

8. A method for prepaid calling card restriction according to claim 7, further comprising the step of:
when said prepaid calling card is used, accessing said account information and said at least one phone card restriction from said database; and
if said restriction is valid, preventing said prepaid calling card from being used for that particular restriction.

9. A method for prepaid calling card restriction according to claim 7, wherein said at least one phone card restriction includes at least one phone number, wherein said prepaid calling card can only be used to dial phone numbers that are included in said at least one phone number.

10. A method for prepaid calling card restriction according to claim 7, wherein said at least one phone card restriction includes at least one phone number, wherein said prepaid calling card can not be used to dial phone numbers that are included in said at least one phone number.

11. A method for prepaid calling card restriction according to claim 7, wherein said at least one phone card restriction includes at least one day of the week, wherein said prepaid calling card can only be used on days of the week that are included in said at least one day of the week.

12. A method for prepaid calling card restriction according to claim 7, wherein said at least one phone card restriction includes at least one time range, wherein said prepaid calling card can only be used at times that are included in time ranges within said at least one time range.

13. A method for prepaid calling card restriction according to claim 7, wherein said at least one phone card restriction includes at least one period restriction, each period restriction including a time period and a message unit limit, wherein said prepaid calling card can only be used for said message unit limit during said at time period.

14. A system for prepaid calling card activation with restrictions, comprising:
A computer, said computer having a database for tracking prepaid calling card information and prepaid calling card usage, said computer configured to access to a communications network;
a point of sale terminal, said point of sale terminal configured to authorize a prepaid calling card, said point of sale terminal configured to read account information from said prepaid calling card, said point of sale terminal configured to capture restriction information related to said prepaid calling card, said point of sale terminal configured to send said account information and said restriction information to said computer through said communications network, wherein said account information and said restriction information are entered into said database; and
a phone system configured to connect calling parties to called parties, said phone system connected to said computer, said phone system configured to allow the usage of said prepaid calling cards after an access to said database indicates that said prepaid calling card is valid and said prepaid calling card has sufficient message units and none of the restriction information of said prepaid calling card is violated.

15. A system for prepaid calling card activation with restrictions according to claim 14, wherein said restriction information includes at least one phone number, wherein said prepaid calling card can only be used to dial phone numbers that are included in said at least one phone number.

16. A system for prepaid calling card activation with restrictions according to claim 14, wherein said restriction information includes at least one phone number, wherein said prepaid calling card can not be used to dial phone numbers that are included in said at least one phone number.

17. A system for prepaid calling card activation with restrictions according to claim 14, wherein said restriction information includes at least one day of the week, wherein said prepaid calling card can only be used on days of the week that are included in said at least one day of the week.

18. A system for prepaid calling card activation with restrictions according to claim 14, wherein said restriction information includes at least one time range, wherein said prepaid calling card can only be used at times that are included in time ranges within said at least one time range.

19. A system for prepaid calling card activation with restrictions according to claim 14, wherein said restriction information includes at least one period restriction, said at least one period restriction including a specified number of message units, wherein said prepaid calling card can only be used for said specified number of message units during said at least one period restriction.

20. A system for prepaid calling card activation with restrictions according to claim 14, wherein said computer comprises at least one central processing unit.
